(19) United States
(12) Patent Application Publication
(10) Pub. No.: US 2004/0202850 A1
(43) Pub. Date: Oct. 14, 2004

(54) Luminous sheet and production method therefor

(76) Inventors: Yutaka Hayashi, Nomi-gun (JP); Junsho Kanenori, Nomi-gun (JP); Koji Mori, Nomi-gun (JP); Koji Nakade, Nomi-gun (JP)

Correspondence Address: BLANK ROME LLP, 600 NEW HAMPSHIRE AVENUE, N.W., WASHINGTON, DC, 20037, US

(21) Appl. No.: 10/820,119

(22) Filed: Apr. 8, 2004

(30) Foreign Application Priority Data
Apr. 10, 2003 (JP) P2003-106505
Sep. 18, 2003 (JP) P2003-325368
Jan. 21, 2004 (JP) P2004-13078

(51) Int. Cl. B32B 3/00

(52) U.S. Cl. 428/212

(57) ABSTRACT

The present invention aims to provide a luminous sheet that emits sufficient light and provides enough luminance to enable recognition, is lightweight and pliable, and for which application and working are simple. The present invention further aims to provide a production method for this luminous sheet. The luminous sheet according to the present invention comprises a light reflecting layer and a luminescent layer in which a luminescent agent is included in the range of (40˜400 g/m²)×(coverage ratio % /100%).

### BACKGROUND OF THE INVENTION

1. Field of the Invention

The present invention relates to a luminous sheet that is visible at night, in dark areas or during power failures, for which application and working are simple. The present invention further relates to a production method for this luminous sheet.

2. Description of Related Art

A luminous sheet is a sheet that has luminescence, such as, for example, a sheet spread with a synthetic resin into which a luminescent agent or luminous pigment has been kneaded.

The luminescent agent or luminous pigment that is included in this luminous sheet is a substance that absorbs light (solar light, fluorescent light, etc.) for a given period of time (1 to 20 minutes, for example), stores (excites) this light, and then continuously emits light in the dark for a specific period of time (from 30 minutes to 8 hours). Zinc sulfide or the like is a conventionally known example of such a substance. In addition, in recent times, the use of strontium aluminate, which has superior luminance and afterglow performance as compared to zinc sulfide, has also been proposed.

As an example of a luminous sheet, a sheet has been proposed in which the edge portion of a luminous printed pattern is covered by a colored-printed layer, and this sheet also having a pressure-sensitive layer (see Document 1). By protecting the surface with a colored-printed layer, this luminous sheet has improved weather- and water-resistant properties. Further, this sheet has improved workability through the provision of a pressure-sensitive layer, and is suitable for such applications as advertisements or safety sign sheets.

As luminescent fiber products other than luminous sheets, a product has been proposed that utilizes a conjugate fiber employing a polymer containing 10 wt % or more of a luminous pigment as a core component and a transparent polymer as a sheath component (see Document 2). A product has also been proposed that utilizes a water-resistant conjugate fiber in which the core component consists of a polymer containing a luminous pigment, and the outermost layer consists of a polymer having a coefficient of water absorption of 0.5 or less (see Document 3).

Document 1: Japanese Patent Application, Publication No.: 10-287851

Document 2: Japanese Patent Application, Publication No.: 02-112414

Document 3: Japanese Patent Application, Publication No.: 2001-123328

In order that sufficient light can be emitted to obtain enough luminance to permit recognition, there has been a desire in the case of luminous sheets not only to improve the performance of the luminescent agent or luminous pigment, but also to provide the resin layer containing the luminescent agent or luminous pigment at a given density and thickness.

In general, however, in products that have excellent luminescence, the resin layer containing the luminescent agent or luminous pigment is thick, and the pliability of the luminous sheet becomes poor. As a result, a problem arises in that, when wound in a roll, which is the typical state employed for product transport, the sheet tends to curl again after unrolling, making application and workability more difficult. In addition, in the case of severe folding over before or after application or working, the design can be greatly impaired because cracks and bending fold or bending line traces remain in the luminescent layer. In particular, when the luminous sheet is used as a wallpaper or as folding paper, the above-described problems become marked because it is necessary to employ a base that is thick and bulky.

In addition, it is often the case that special skilled techniques are required not only for handling in the transport state or before and after application and working, but also during application and working.

Patent Documents 2 and 3 disclose only the provision of a luminescent agent or luminous pigment via a spinning step, in a fiber having at least a two-layer structure divided between a core component and a sheath component, and do not disclose any method for resolving the above-described problems.

### BRIEF DESCRIPTION OF THE DRAWINGS

FIG. 1 is a cross-sectional view showing a luminous sheet according to the first embodiment of the present invention.

FIG. 2 is a cross-sectional view showing a luminous sheet according to the second embodiment of the present invention.

FIG. 3 is a cross-sectional view showing a luminous sheet according to the third embodiment of the present invention.

FIG. 4 is a cross-sectional view showing a luminous sheet according to the fourth embodiment of the present invention.

FIG. 5 is a cross-sectional view of a luminous sheet according to the second embodiment in which an adhesive layer is laminated.

### BRIEF SUMMARY OF THE INVENTION

The present invention was conceived in view of the above-described circumstances, and has as its objective the provision of a luminous sheet that emits sufficient light, provides enough luminance to enable recognition, is lightweight and pliable, and for which application and working are simple. The present invention further relates to a production method for this luminous sheet.

The luminous sheet according to the present invention comprises a light reflecting layer and a luminescent layer in which a luminescent agent is included in the range of (40˜400 g/m²)×(coverage ratio % /100%).

The luminescent layer and the light reflecting layer may be adjacent in the present invention's luminous sheet.

The light reflecting layer in the present invention's luminous sheet may be a sheet base material having a L value of 90 or more.

The present invention's luminous sheet may have a flameproof layer.

The present invention's luminous sheet may have a sheet base material.

When the present invention's luminous sheet has a flameproof layer, the luminescent layer and the flameproof layer may be adjacent to each other, and the flameproof layer and the light reflecting layer may be adjacent to each other.

It is preferable that the flameproof layer have a L value of 90 or more.

When the present invention's luminous sheet has a sheet base material, an adhesive layer may be provided to the sheet base material.

The sheet base material may be a wallpaper base material.

The luminescent layer in the present invention's luminous sheet may include a polyurethane resin.

It is preferable to adhere a transparent sheet to the surface of the luminescent layer in the present invention's luminous sheet.

The production method for a luminous sheet according to claim 12 of the present invention comprises a step for laminating one of either the light reflecting layer or the luminescent layer containing a luminescent agent in the range of 40˜400 g/m² to the other layer by coating.

The production method for a luminous sheet according to claim 13 of the present invention is comprises a step for laminating one of either the light reflecting layer or the luminescent layer containing a luminescent agent in the range of (40˜400 g/m²)×(coverage ratio % /100%) to the other layer by printing.

The production method for a luminous sheet according to claim 14 of the present invention comprises a step for adhering the light reflecting layer and the luminescent layer containing a luminescent agent in the range of 40˜400 g/m² together.

The production method for a luminous sheet according to claim 15 of the present invention comprises a step for laminating the light reflecting layer and the flameproof layer together, and a step for laminating one of either the flameproof layer or the luminescent layer containing a luminescent agent in the range of 40˜400 g/m×coverage ratio to the other layer by coating.

The production method for a luminous sheet according to claim 16 of the present invention comprises a step for laminating the light reflecting layer and the flameproof layer together, and a step for laminating one of either the flameproof layer or the luminescent layer containing a luminescent agent in the range of (40˜400 g/m²)×(coverage ratio % /100%) to the other layer by printing.

The production method for a luminous sheet according to claim 17 of the present invention comprises a step for laminating the light reflecting layer and the flameproof layer together, and a step for adhering the flameproof layer and the luminescent layer containing a luminescent agent in the range of 40˜400 g/m×coverage ratio together.

The production method for a luminous sheet according to claims 12 to 17 of the present invention may have a step for laminating the light reflecting layer and the sheet base material together.

The production method for a luminous sheet according to claims 12 to 14 of the present invention may have a step for laminating the light reflecting layer and the flameproof layer together.

In the above-described production methods for a luminous sheet, it is also acceptable to laminate together a luminescent layer and a transparent sheet.

The luminous sheet according to the present invention emits sufficient light and provides enough luminance to enable recognition. As a result, it has superior visibility at night, in dark places or during power outages. In addition, since the thickness of the luminescent layer can be freely controlled, the luminous sheet can be made highly lightweight and pliable, so that application and working are simple.

In the present invention's production method for a luminous sheet, it is possible to produce a luminous sheet that is highly luminous and pliable. In addition, the pliability can be even further improved when the luminescent layer is laminated by printing or adhering.

### DETAILED DESCRIPTION OF THE INVENTION

The present invention's luminous sheet is a sheet having at least a luminescent layer and a light reflecting layer. The term “luminous” as employed in the present invention means that there is a long (around 30 minutes or more) duration of emission of the phosphorescence that is generated when a material absorbs light, transitions from a base state to an excited (triplet) state, then releases light and again returns to the base state. Since this luminescence is manifested as a result of irradiation by light, it is necessary that the luminescent layer be provided in a location where light will reach it.

The luminescent layer that composes the luminous sheet is a layer containing a luminescent agent and a binder.

In addition, in the case of a spaced pattern (i.e., a pattern with spacing in between), the luminescent layer includes not only the area in which the material containing the luminescent agent and binder is present, but also the areas of space that are surrounded by this material.

Luminous pigments like calcium sulfide pigment or zinc sulfide pigment, for example a zinc sulfide derived luminous fluorescent material such as sulfide-derived fluorescent materials like ZnS:Cu (green emission), CaSrS:Bi (blue emission), ZnCdS:Cu (yellow to orange emission), or an aluminate of an alkaline earth metal in which Europium or the like is activated such as disclosed in Japanese Patent Application, Publication No. Hei 07-011250, may be employed as the luminescent agent. The aluminate of an alkaline earth metal in which Europium is activated is preferred from among these, from the perspective of its light resistance, chemical stability, and luminous ability. Examples of an aluminate of an alkaline earth metal in which Europium is activated include those employing strontium aluminate (SrAl₂O₄) as the base material, of which the product LumiNova® G300 (produced by Nemoto & Co., Ltd.) may be cited.

Examples of the binder for the luminescent layer that may be cited include acrylic resin, polyester resin, polyurethane resin, and silicon resin among others.

The luminescent agent preferably has a particle diameter in the range of 5˜200 μm. When the particle diameter is less than 5 μm, there may not be sufficient luminescence, while, when the particle diameter exceeds 200 μm, silting or lines can occur during coating, adhering, or printing when producing the luminous sheet.

The luminescent agent is included in the luminescent layer in the range of (40˜400 g/m²)×(coverage ratio % /100%), and preferably in the range of (70˜300 g/m²)×(coverage ratio % /100%). When the luminescent agent is contained in a quantity less than 40 g/m²×(coverage ratio % /100%), luminance tends to fall below that essentially possessed by the luminescent agent. Further, when the luminescent agent is contained in an quantity exceeding 400 g/m²×(coverage ratio % /100%), then the strength of the luminescent layer falls, which could lead to a decrease in quality from hydrolysis, etc.

The range (40˜400 g/m²) used here is the quantity of luminescent agent in the areas where the material containing the luminescent agent and the binder is present. The term “coverage ratio” is the percentage of the area in which the luminescent agent is present with respect to the total area of the sheet (i.e., width×length of the luminous sheet). In the case of a luminescent layer having a total surface pattern, i.e., a pattern over the entire surface, then the coverage is 100%. In the case of a luminescent layer having a spaced pattern, such as a dot pattern, the coverage is less than 100%.

Thus, the quantity of luminescent agent as determined by (40˜400 g/m²)×(coverage ratio % /100%) is the quantity of luminescent agent per total area of the sheet. For example, when a luminescent layer having a coverage ratio of 30% is provided, the quantity of luminescent agent per total area of the sheet is (40˜400 g/m²)×(30/100)=12˜120 g/m². To state this in a different way, when the coverage ratio is 30% and the quantity of luminescent agent per total area of the sheet is 12˜120 g/m², then the quantity of luminescent agent in the area where the material containing the luminescent agent and the binder is present (or the quantity of luminescent agent when converted to a total surface pattern) is 40˜400 g/m².

The thickness of the luminescent layer will depend on the particle diameter in the luminescent agent, but a range of 10˜400 μm is preferred.

The light reflecting layer that composes the luminous sheet may be a layer having a L value of 90 or more, or a layer in which the surface is mirrored. As a result of this type of layer, light that passes through the luminescent layer can be reflected to again incident on the luminescent layer, so that the efficiency of light energy absorption by the luminescent agent can be increased, and the luminance of the luminescent layer can be increased. Note that when the L value is less than 90, light is absorbed, so that the luminance of the luminescent layer in the luminous sheet cannot be made sufficiently high. Thus, a layer having a L value of less than 90 cannot be deemed a light reflecting layer.

Note that the L value as used here is the brightness, and is expressed by taking the whiteness of MgO as 100. The larger the L value, the brighter. For example, in the case of a gray film having a L value of 50, the luminance is approximately 60% lower than a white with a L value of 95.

As a method to increase the L value to 90 or above, a method may be cited in which a given quantity or more of a light reflecting agent is included in the binder. White pigments and dyes, including titanium oxide and aluminum oxide, may be cited as examples of light reflecting agents. Acrylic resin, polyester resin, polyurethane resin, and silicon resin may be cited as examples of binders.

The quantity of the light reflecting agent contained will depend on the type of binder, however, it is preferable that there be 10˜300 parts of the white pigment to 100 parts by weight of the resin solid component.

Provided that the sheet is one having a L value of 90 or more, then the sheet itself may be used as the light reflecting layer, without including a separate light reflecting agent.

As a method for applying a mirrored face to the surface, a method may be cited in which aluminum foil is laminated or deposited to a polyethylene terephthalate base.

Preferred embodiments 1˜4 of a luminous sheet having a luminescent layer and a light reflecting layer as described above will now be explained.

(First Preferred Embodiment)

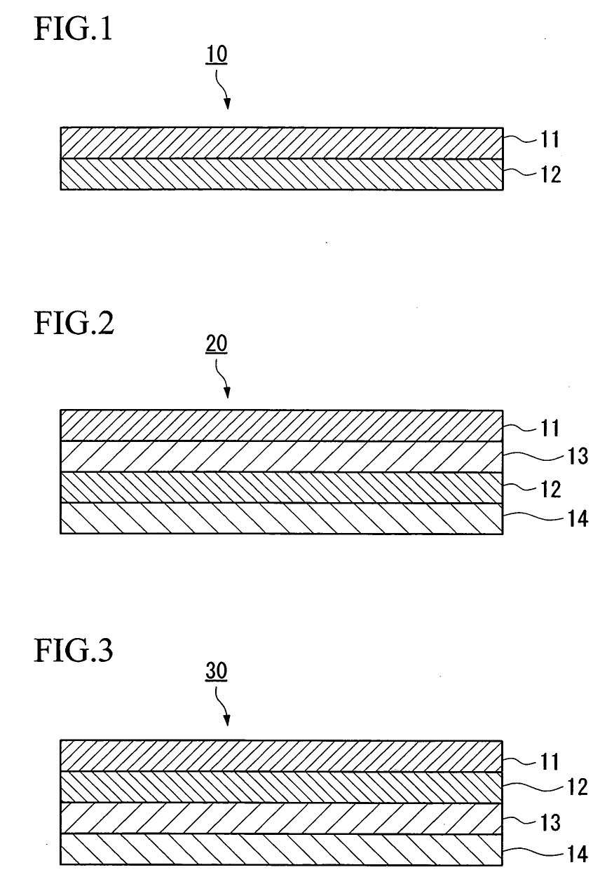

The structure of a sheet according to a first embodiment of the present invention is shown in FIG. 1. In this luminous sheet 10, luminescent layer 11 and light reflecting layer 12 are adjacent to each other.

In this embodiment, light reflecting layer 12 is a sheet base material having a L value of 90 or higher. By having a L value of 90 or more for the sheet base material, the sheet base material can also function as a light reflecting layer, so that a separate light reflecting layer does not need to be provided on top of the sheet base material. Accordingly, the luminous sheet in this embodiment has the simplest structure.

In the luminous sheet according to the present embodiment, of the light that radiates onto luminescent layer 11, the light that passes through without being absorbed by luminescent layer 11 is reflected at light reflecting layer 12 and again incidents on luminescent layer 11. As a result, the efficiency of absorption of the light energy that radiates on the luminescent layer becomes high, and the quantity of light energy that is absorbed by the luminescent agent is large. Thus, the luminance of the luminescent agent becomes high. In addition, since the efficiency of absorption of light energy at luminescent layer 11 is high, sufficient luminance is obtained even if luminescent layer 11 is made thin, and, by making luminescent layer 11 thin, pliability can be ensured.

As an example of the sheet base material, various types of paper typically employed as a wallpaper base material having a basis weight (per cubic meter) of 50˜200 g may be cited, including synthetic paper, Japanese paper, non-combustible paper, flame retardant paper, a compound paper of various types selected from among these, or biodegradable paper. In addition, material such as acrylic resin, polypropylene resin, polyethylene resin, polystyrene resin, polyurethane resin, silicon resin, polytetrafluoroethylene (PTFE), or polyethylene terephthalate (PET) in the form of a film or sheet may also be cited.

It is also acceptable for the sheet base material to be a cloth, knit or nonwoven fabric of a synthetic fiber such as polyester or polyamide, a semi-artificial fiber like rayon, a natural fiber like cotton or wool, or a mixture of the preceding.

The sheet base materials from among these that are applicable in the current embodiment are those having a L value of 90 or more.

The thickness of the sheet base material is preferably 10˜10000 μm. When the thickness is less than 10 μm, the base curls, etc., during application and working, so that it can become difficult to separate the releasable paper in the adhering production. Further, when the thickness of the base exceeds 10000 μm, this departs from the goal of making the material more lightweight and can create a hindrance during work such as unrolling because of diminished pliability.

Next, methods for producing the luminous sheet according to the first embodiment of the present invention will be explained. The following three methods are available as methods for producing the first embodiment's luminous sheet.

The first method is a method in which a luminescent layer is laminated to a sheet base material (light reflecting layer) having a L value of 90 or more by coating a resin solution containing a luminescent agent and a binder thereto. “Laminate” as used here means two layers that are formed adjacent to each other.

In this first method, various methods may be cited for formulating the resin solution of the luminescent agent and the binder. For example, there is a method for formulating an aqueous solution in which a water-based binder and luminescent agent are dissolved in an aqueous solvent (water and/or a aliphatic lower alcohol of 1˜3 carbons), and a method for formulating a solution in which a solvent-based binder and luminescent agent are dissolved in an organic solvent (dimethylformamide, methylethylketone, toluene, etc.).

The compounding ratio of the luminescent agent and the binder is the ratio such that the quantity of luminescent agent will be (40˜400 g/m²)×coverage ratio when the luminescent layer is formed. However, in the first method, since the luminescent layer is provided to the entire surface of the sheet, the coverage ratio is 100%.

The quantity of solvent is preferably in the range of 300˜2000 parts by weight with respect to 100 parts by weight solid component.

While the adhesive property increases when the quantity of the solvent is less than 300 parts by weight, viscosity becomes greater, creating a hindrance during coating. In contrast, when the quantity of the solvent exceeds 2000 parts by weight, viscosity becomes too low, so that it may not be possible to form a layer.

Flame proofing agents, oxidation inhibitors, antimicrobial agents and the like may be suitably added to the above-described resin solution. In this case, however, it is preferable that transparent agents be used.

The second method is one in which the luminescent layer is laminated to a sheet base material (light reflecting layer) having a L value of 90 or more by printing a resin solution containing a luminescent agent and a binder thereto.

Conventional methods such as screen printing, roller printing and gravure printing may be cited as examples of the printing employed in this second method. Screen printing, however, is preferred from the perspective of making the luminescent layer (ink layer) thick. Screen printing is also preferable in view of the fact that spaced patterns, such as dots, broken lines or stardust patterns, enable greater pliability than a total surface pattern. Note that when providing a luminescent layer having a spaced pattern created using screen printing, the coverage ratio is less than 100%, so that the quantity of luminescent agent per total area of the sheet is (40˜400 g/m ²)×(coverage ratio % /100%). Further, the screen is in the form of a mesh with openings. Thus, when determining the quantity of luminescent agent, the ratio of the area of openings in the screen with respect to the area of the screen (i.e., the screen open ratio) must be taken into consideration. For example, in the case of screen printing using a flat-type print (fixed frame, moving squeegee), the open ratio is 10˜80%, while in the case of screen printing using a rotary-type print (rotating frame, fixed squeegee), the open ratio is 5˜30%. This value is determined by the size of the mesh and the type of gauze.

The method for formulating the resin solution containing the luminescent agent and the binder is the same as in the first method.

Note that when employing printing to form a luminescent layer having a solid pattern over the entire surface, there is a concern that pliability will suffer.

The third method is a method (laminate) in which the luminescent layer is adhered to a sheet base material (light reflecting layer) having a L value of 90 or more. If this type of adhering method is employed, penetration of the resin can be limited with respect to a base material such as paper into which resin easily penetrates. Thus, pliability can be easily ensured even in the case of a total surface pattern.

As the method for forming the luminescent layer in this third method, a method may be cited in which a resin solution containing a luminescent agent and a binder are coated all over a releasable paper. In this case, when coating the resin solution containing the luminescent agent and the binder onto the releasable paper, a conventionally known coating device such as a knife coater, pipe coater, comma coater, or the like may be employed. The method for formulating the resin solution containing the luminescent agent and the binder is the same as in the first method.

Alternatively, a commercially available film product containing a luminescent agent may be employed as the luminescent layer.

It is acceptable to employ an adhesive agent when adhering the layers. In this case, a luminescent agent may be added to the adhesive agent. However, when too much luminescent agent is included in the adhesive agent, this can lead to a decrease in the peel strength. Therefore, the quantity of luminescent agent included in the adhesive agent should be less than that included in the luminescent layer.

Note that when a luminescent layer is provided to the entire surface of the sheet, the coverage ratio is 100%.

In the first through third methods, it is also acceptable for the luminescent layer to consist of a plurality of layers formed by repeated coating, printing and adhering.

In these methods for producing a luminous sheet, the luminescent layer can be made to a suitable thickness and the quantity of luminescent agent per unit area can be easily controlled so as to ensure luminescence. Thus, the luminance of the luminescent layer can be increased. At the same time, the efficiency of absorption of light energy can be increased by forming the luminescent layer on top of the light reflecting layer. As a result, the luminescent layer does not need to be made to a thickness that would impair pliability. In particular, when forming a luminescent layer with a spaced pattern onto a sheet base material by printing, or when forming a luminescent layer, even one with a solid pattern covering the entire surface, to a sheet base material by adhering, pliability can be increased even further.

In contrast, when forming a luminescent layer by deposition or spraying, it is difficult to form the layer with a thickness that permits sufficient luminance to be obtained.

(Second Embodiment)

The structure of the luminous sheet according to a second embodiment of the present invention is shown in FIG. 2. This luminous sheet 20 has a luminescent layer 11, a flameproof layer 13 that is in contact with luminescent layer 11, a light reflecting layer 12 that is in contact with flameproof layer 13, and a sheet base material 14 that is in contact with light reflecting layer 12.

In this embodiment, the light reflecting layer and the sheet base material have separate structures, so that a material may be used for sheet base material 14 that assumes a dark or intermediate color that has a L value of less than 90.

Flameproof layer 13 is a layer containing a flameproof agent. Examples of flameproof agents include phosphorous based flameproof agents or halogen based flameproof agents, examples thereof including decabromodiphenyl ether and antimony trioxide.

When flameproof layer 13 is positioned between luminescent layer 11 and light reflecting layer 12 as in this embodiment, it is particularly preferable that the L value of flameproof layer 13 be 90 or more. If the L value of flameproof layer 13 is 90 or more, then flameproof layer 13 can also function as a light reflecting layer. Light that has passed through the luminescent layer is reflected at flameproof layer 13 and incidents again on the luminescent layer. As a result, the efficiency of absorption of light energy by the luminescent agent can be made even higher, and the luminance of the luminescent layer can be made even greater. In contrast, when the L value of the flameproof layer 13 is less than 90, light is absorbed at flameproof layer 13. The efficiency of absorption of light energy by the luminescent agent falls, and the luminance of the luminescent layer decreases.

Further, in order to have flameproof layer 13 sufficiently express the effects of a light reflecting layer 12, it is preferable to make it transparent so that the quantity of light absorption is small.

The thickness of flameproof layer 13 is acceptable provided that it is sufficient to express flameproof properties. A thinner layer, however, facilitates expression of the effects of a light reflecting layer 12.

In the luminous sheet according to this embodiment, of the light that radiates onto luminescent layer 11, the light that passes through without being absorbed by luminescent layer 11 is reflected by flameproof layer 13 or light reflecting layer 12, and again incidents on luminescent layer 11. As a result, the efficiency of absorption of the light energy that radiates on the luminescent layer becomes higher, and the quantity of light energy that is absorbed by the luminescent agent is great. Thus, the luminance of the luminescent agent becomes high. In addition, since the efficiency of light energy absorption at luminescent layer 11 is high, sufficient luminance is obtained even if luminescent layer 11 is made thin, and, by making luminescent layer 11 thin, pliability can be ensured.

Further, since the luminous sheet according to this embodiment has a flameproof layer 13, the flameproof properties of this sheet are greater.

Next, the method for producing a luminous sheet according to the second embodiment of the present invention will be explained.

The method for producing a luminous sheet according to a second embodiment of the present invention has a step for forming a light reflecting layer on a sheet base material, a step for forming a flameproof layer on this light reflecting layer, and a step for forming a luminescent layer on this flameproof layer.

The step for forming the light reflecting layer and the flameproof layer in this production method is acceptable as long as each layer can be formed in a way so as to perform its function. For example, any of the methods of coating, printing, depositing or spraying the resin solution containing a light reflecting agent or flameproof agent to the targeted layer may be employed.

In the case where employing polyurethane resin as the binder and a white pigment as the light reflecting agent in the formulation of a resin solution containing a light reflecting agent, it is preferable when mixing the white pigment and the polyurethane resin that the pigment solid component of the white pigment be compounded in the range of 20˜600 parts by weight, and more preferably in the range of 100˜200 parts by weight, with respect to 100 parts by weight of the resin solid component.

In order to prevent precipitation of the white pigment, the viscosity of the resin solution is preferably in the range of 3,000˜50,000 cps, and more preferably 5,000˜30,000 cps. It is necessary to increase the viscosity in order to have it in this range. As a method to accomplish this, the method of adding a cross-linking agent may be cited, for example. Further, if an organic solvent system is used, the method of adjusting the solid component concentration by using a macromolecular resin may be cited.

As a method for forming the light reflecting layer and the flameproof layer, it is acceptable to separately form the light reflecting layer and the flameproof layer by coating a resin solution containing a light reflecting agent or a flameproof agent to a releasable paper, and then adhering the light reflecting layer or the flameproof layer to the target layer. An adhesive agent may be employed when adhering, and a luminescent agent, light reflecting agent or flameproof agent may be added to this adhesive agent.

As a method for forming this luminescent layer, a method may be employed in which the flameproof layer is substituted for the sheet base material (light reflecting layer) having a L value of 90 or greater in the method described in the First Embodiment.

Any order may be employed as the order for forming each of the layers. For example, it is acceptable to laminate the light reflecting layer, flameproof layer and luminescent layer, in this order, onto the sheet base material, or to form the luminescent layer onto the releasable paper, and then form the flameproof layer, light reflecting layer and sheet base material, in this order, onto the luminescent layer.

(Third Embodiment)

The structure of the luminous sheet according to a third embodiment of the present invention is shown in FIG. 3. This luminous sheet 30 has a luminescent layer 11, a light reflecting layer 12 in contact with luminescent layer 11, a flameproof layer 13 in contact with light reflecting layer 12, and a sheet base material 14 in contact with flameproof layer 13. In this embodiment, luminescent layer 11 is in contact with light reflecting layer 12, so it is not problematic even if the L value of flameproof layer 13 is less than 90.

In the luminous sheet according to the present embodiment, of the light that radiates onto luminescent layer 11, the light that passes through without being absorbed by luminescent layer 11 is reflected at light reflecting layer 12 and again incidents on luminescent layer 11. As a result, the efficiency of absorption of the light energy that radiates on the luminescent layer becomes high, and the quantity of light energy that is absorbed by the luminescent agent is great. Thus, the luminance of the luminescent agent becomes high. In addition, since the efficiency of absorption of light energy at luminescent layer 11 is high, sufficient luminance is obtained even if luminescent layer 11 is made thin, and, by making luminescent layer 11 thin, pliability can be ensured.

Further, since the luminous sheet according to this embodiment has a flameproof layer 13, the flameproof properties of the sheet become high.

Next, the method for producing a luminous sheet according to a third embodiment of the present invention will be explained.

The method for producing the luminous sheet according to a third embodiment of the present invention has a step for forming a fireproof layer on a sheet base material, a step for forming a light reflecting layer on this flameproof layer, and a step of forming a luminescent layer on this light reflecting layer.

The same method as used in the second embodiment can be employed as the step for forming this light reflecting layer and flameproof layer in this production method. As the step for forming the luminescent layer, a method can be used in which a light reflecting layer is substituted for the sheet base material (light reflecting layer) having a L value of 90 or greater in the method described in the first embodiment.

Any order may be employed as the order for forming the layers. For example, it is acceptable to laminate the flameproof layer, light reflecting layer, and luminescent layer, in this order, onto the sheet base material, or to form the luminescent layer onto the releasable paper, and then form the light reflecting layer, flameproof layer, and sheet base material, in this order, onto the luminescent layer.

(Fourth Embodiment)

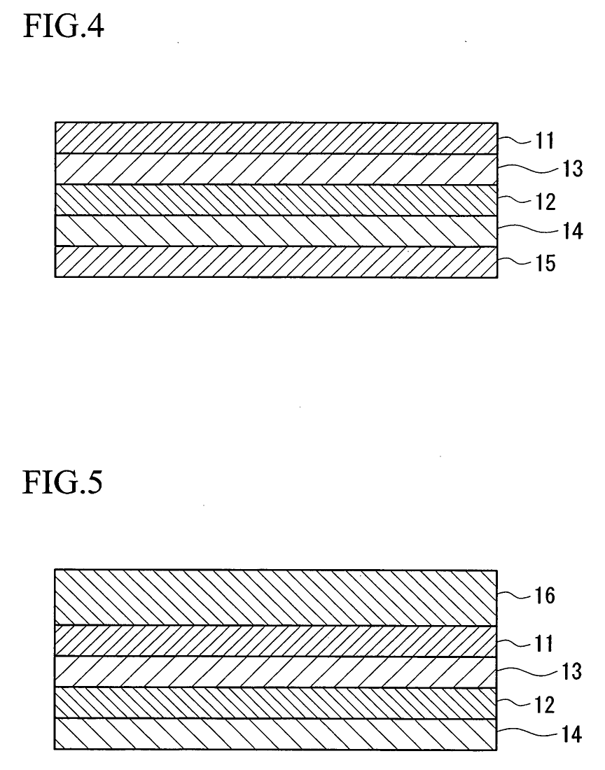

The structure of the luminous sheet according to a fourth embodiment of the present invention is shown in FIG. 4. This luminous sheet has a transparent sheet 15, a luminescent layer 11 in contact with transparent sheet 15, a flameproof layer 13 in contact with luminescent layer 11, and a light reflecting layer 12 in contact with flameproof layer 13.

The transparent sheet 15 used here is one through which light sufficiently passes and is able to reach the luminescent agent. Transparent sheet 15 is not particularly restricted, so long as the luminescent layer can be formed by coating or adhering. Specific examples of a transparent sheet that may be cited include sheets of acrylic resin, polypropylene resin, polyethylene resin, polystyrene resin, polyurethane resin, silicon resin, polytetrafluoroethylene (PTFE), polyethylene terephthalate (PET) and the like, a compound resin sheet consisting of various types selected from among these, or a biodegradable resin sheet.

It is preferable that the emitted phosphorescence be sufficiently transmitted through this transparent sheet. The luminescent agent is excited by absorbing light rays in the 200˜500 nm light wavelength region in particular. Since there are numerous products that emit phosphorescence at light wavelengths of 450˜550 nm, it is preferable that light transmissivity in the phosphorescent wavelength region be 60% or more.

The thickness of the transparent layer is preferably 10˜1000 μm. When the thickness is less than 10 μm, the sheet curls, etc., during working, so that it can become difficult to separate the releasable paper in the adhering process. Further, when the thickness of the transparent layer exceeds 1000 μm, this can create a hindrance during work such as unrolling because of diminished pliability.

In the luminous sheet of this embodiment, of the light that passes through transparent sheet 15 and incidents onto luminescent layer 11, the light that passes through without being absorbed by luminescent layer 11 is reflected at light reflecting layer 12 and again incidents on luminescent layer 11. As a result, the efficiency of absorption of the light energy that radiates on the luminescent layer becomes high. Thus, the luminance of the luminescent layer increases. In addition, since the efficiency of light energy absorption at luminescent layer 11 is high, sufficient luminance is obtained even if luminescent layer 11 is made thin, and, by making luminescent layer 11 thin, pliability can be ensured.

Further, by laminating the transparent sheet to the surface of the luminescent layer, luminescent layer 11 is protected, so that durability (i.e., resistance to weather, water, etc.) is greatly improved.

Next, the method for producing a luminous sheet according to the fourth embodiment of the present invention will be explained. The method for producing a luminous sheet according to a fourth embodiment of the present invention has a step for forming a luminescent layer on top of the transparent sheet, a step for forming a flameproof layer on top of this luminescent layer, and a step for forming a light reflecting layer on this flameproof layer.

The same method as employed in the second embodiment may be used for the step for forming the light reflecting layer and flameproof layer in this production method. As the step for forming the luminescent layer, a method can be used in which a transparent sheet is substituted for the sheet base material (light reflecting layer) having a L value of 90 or greater in the method described in the first embodiment.

Any order may be employed as the order in which each of the layers is formed. For example, it is acceptable to laminate the luminescent layer, flameproof layer, and light reflecting layer, in this order, onto the transparent sheet, or to form the light reflecting layer onto the releasable paper, and then form the flameproof layer, luminescent layer, and transparent sheet, in this order, on top of the light reflecting layer.

In the first through fourth embodiments described above, the efficiency of absorption of light energy at the luminescent layer becomes high by means of the light reflecting layer, so that luminance increases. As a result, the luminescent layer can be made thin, and pliability can be increased. Thus, it is possible to obtain a product in which both luminescence and pliability are high. As a result of the high pliability, it is possible to prevent the re-rolling tendency that occurs when the material is unrolled, facilitating application and working. In addition, even in the case of severe folding over before or after application or working, the design can be ensured because bending fold or bending line traces do not readily remain.

Note that it is acceptable to laminate an adhesive layer 16 to sheet base material 14 in the above-described first through fourth embodiments. As an example, FIG. 5 shows a design in which an adhesive layer 16 is laminated to sheet base material 14 in a luminous sheet according to the second embodiment. If adhesive layer 16 is laminated to sheet base material 14 in this way, then the application and workability of the luminous sheet are even further improved.

Various additives such as dyes, pigments, oxidation inhibitors, antimicrobial agents or the like may be included in the light reflecting layer or flameproof layer in the above-described first through fourth embodiments. In addition, it is also acceptable to add powders such as glass or quartz powders with the goal of irregularly reflecting the light, etc., and improving visibility.

The present invention's luminous sheet has a sheet base material. When this sheet base material is a wallpaper base material, then the luminous sheet may be used as a luminous wallpaper.

Examples of the present invention will now be explained. Note that in the following examples, “%” indicates wt % and “part” indicates parts by weight.

### EXAMPLES

### Example 1

Non-combustible paper of basis weight (per cubic meter) 50 g and thickness 50 μm, was prepared as a sheet base material with a L value of 95. Next, a resin solution was formulated containing 100 parts water-based single liquid urethane resin (solid component 10%), 40 parts water, and 120 parts luminous pigment LumiNova® G300 (produced by Nemoto & Co., Ltd.), which is the luminescent agent. This resin solution was printed to the aforementioned sheet base material using an automated screen printer equipped with 135 mesh screen having a dot diameter of 5 mm and dot pitch of 10 mm, and dried for 30 seconds at 150° C., to obtain a luminous sheet.

Note that, including this Example 1, the quantity of luminescent agent as reported in the tables in the case where the luminescent layer is provided by screen printing, is the value obtained by converting to a total surface pattern. The phrase “value converted to a total surface pattern” as used here is the value obtained from {quantity of luminescent agent per sheet total area/(coverage ratio/100%)}, (i.e., calculated after taking into consideration the coverage ratio and the open ratio when screen printing). In this example, the coverage ratio is 38%, and the open ratio of the screen was 65%.

### Comparative Example 1

A luminous sheet was obtained in the same manner as in Example 1, with the exception that a non-combustible paper of basis weight (per cubic meter) 50 g and thickness 50 μm was prepared as a sheet base material having a L value of 75.

### Comparative Example 2

A luminous sheet was obtained in the same manner as in Example 1, with the exception that the quantity of luminous pigment was 50 parts.

The obtained luminous sheet was evaluated using the following evaluation methods. Evaluation results are shown in Table 1.

Luminescence evaluation: A sample obtained by cutting the luminous sheet into a 50×50 mm piece was placed in a dark location and left undisturbed to remove afterglow. Next, light of 200 lux brightness was radiated for 10 minutes from a D65 standard light source. Luminescence was evaluated immediately thereafter, using the following 5 grades.

A: excellent

B: good

C: satisfactory

D: poor

E: bad

Measurement of L value: Measured using the multi-light source spectrophotometer CM-3700d manufactured by Minolta Co., Ltd.

Thickness: Determined in conformity with JIS L-1096 (method 6.5).

Pliability evaluation: A sample prepared by cutting the luminous sheet into a 50×50 mm piece was evaluated for pliability after visually observing its condition following abrasion proof property testing in conformity with JIS L-1096 (method 6.17.A-2).

TABLE 1

| | | | Comp. |
|---|---|---|---|
| | Ex. 1 | Comp. Ex. 1 | Ex. 2 |
| Quantity of luminescent agent (g/m²) | 85 | 85 | 30 |
| (value converted to a total surface pattern) | | | |
| Thickness of luminescent layer (μm) | 100 | 100 | 88 |
| Brightness of sheet base material, L value | 95 | 75 | 95 |
| Evaluation of luminescence | B | D | E |
| Evaluation of pliability | good | good | good |

### Example 2

A sheet base material of polyethylene terephthalate (PET) having a thickness of 75 μm and a L value of 75 was prepared. A urethane resin solution (7000 cps) containing 100 parts polyester ether based single liquid urethane resin (solid component 30%) and 50 parts white pigment having titanium oxide as the main component, was coated to one side thereof to form a light reflecting layer which was dried for 40 seconds at 130° C.

Next, a resin solution was formulated containing 100 parts of a water based single liquid urethane resin (solid component 10%), 40 parts water, and 120 parts luminous pigment LumiNova® G300 (produced by Nemoto & Co., Ltd.), which is the luminescent agent. This resin solution was printed to the aforementioned sheet base material using an automated screen printer equipped with a 135 mesh screen having a dot diameter of 5 mm and a dot pitch of 10 mm, and dried for 30 seconds at a 150° C., to obtain a luminous sheet. The results of the evaluation of this luminous sheet are shown in Table 2.

### Comparative Example 3

A luminous sheet was obtained in the same manner as in Example 2, with the exception that the quantity of luminous pigment was 50 parts. The results of the evaluation of this luminous sheet are shown in Table 2.

### Comparative Example 4

A luminous sheet was obtained in the same manner as in Example 2, with the exception that the quantity of white pigment included in the light reflecting layer was decreased to 0.1 parts and the L value thereof was less than 90. The results of the evaluation of this luminous sheet are shown in Table 2.

TABLE 2

| | | Comp. | Comp. |
|---|---|---|---|
| | Ex. 2 | Ex. 3 | Ex. 4 |
| Quantity of luminescent agent (g/m²) | 85 | 32 | 88 |
| (value converted to a total surface pattern) | | | |
| Thickness of luminescent layer (μm) | 100 | 76 | 105 |
| Brightness of light reflecting layer, L value | 95 | 95 | 70 |
| Evaluation of luminescence | B | E | D |
| Evaluation of pliability | good | good | good |

### Example 3

A non-combustible paper having a basis weight (per cubic meter) of 250 g and a thickness of 100 μm was prepared as a sheet base material. A urethane resin solution (8000 cps) containing 100 parts polyester ether based single liquid urethane resin (solid component 30%), 50 parts toluene, and 50 parts white pigment having titanium oxide as the main component, was coated to one side thereof, and semi-dried for 30 seconds at 120° C., to form a light reflecting layer. Next, a urethane resin solution (9000 cps) containing 100 parts of a polyester ether based two liquid urethane resin (solid component 30%), 12 parts aliphatic isocyanate, 30 parts toluene, 50 parts flameproof agent, and 0.5 parts catalyst was coated to the light reflecting layer using a comma coater. This was then semi-dried for 30 seconds at 120° C., to obtain a laminate of a sheet base material, light reflecting layer, and flameproof layer.

Separate from the above, a resin solution containing 100 parts polyester ether based single liquid urethane resin (solid component 10%), 30 parts toluene, and 120 parts luminous pigment LumiNova® G300 (produced by Nemoto & Co., Ltd.) was coated onto releasable paper using a comma coater having a slit width of 150 μm, and dried for 30 seconds at 120° C. to form a luminescent layer. Next, the flameproof layer of the laminate and the aforementioned luminescent layer were adhered together. After aging for 24 hours at 60° C., the releasable paper was peeled off, to obtain a luminous sheet. The results of the evaluation thereof are shown in Table 3.

### Comparative Example 5

A commercially available wallpaper on which a luminous pigment was deposited was employed as the sheet base material, to obtain a luminous sheet in the same manner as in Example 3. The results of the evaluation of this luminous sheet are shown in Table 3.

### Comparative Example 6

A luminous sheet was obtained in the same manner as in Example 3, with the exception that the luminous pigment in Example 3 was employed in the quantity of 50 parts. The results of the evaluation of this luminous sheet are shown in Table 3.

### Comparative Example 7

A luminous sheet was obtained in the same manner as in Example 3, with the exception that the quantity of white pigment contained in the light reflecting layer was decreased to 0.1 parts, the L value thereof was less than 90, and the luminous pigment was employed in the quantity of 50 parts. The results of the evaluation of this luminous sheet are shown in Table 3.

TABLE 3

| | | Comp. | Comp. | Comp. |
|---|---|---|---|---|
| | Ex. 3 | Ex. 5 | Ex. 6 | Ex. 7 |
| Quantity of luminescent agent (g/m²) | 92 | 17 | 35 | 33 |
| Thickness of luminescent layer (μm) | 120 | 20 | 115 | 115 |
| Brightness of flameproof layer, | 91 | 92 | 92 | 90 |
| L value | | | | |
| Evaluation of luminescence | A | E | C | D |
| Evaluation of pliability | good | peeling | good | good |
| | | present | | |

### Example 4

A urethane resin solution (7000 cps) containing 100 parts polyester ether based single liquid urethane resin (solid component 30%) and 50 parts white pigment having titanium oxide as the main component, was coated using a comma coater to one side of a non-combustible paper having a basis weight of 150 g and a thickness of 75 μm, to form a light reflecting layer which was then dried for 40 second at 130° C. Next, a resin solution including 100 parts water based single liquid urethane resin (solid component 10%), 40 parts water, and 120 parts luminous pigment LumiNova® G300 (produced by Nemoto & Co., Ltd.), the luminescent agent, was formulated. This resin solution was printed to the aforementioned sheet base material using an automated screen printer equipped with 135 mesh screen having a dot diameter of 5 mm and a dot pitch of 10 mm, and dried for 30 seconds at 150° C., to obtain a luminous wallpaper. The results of the evaluation of this luminous wallpaper are shown in Table 4.

### Example 5

Luminous wallpaper was obtained in the same manner as in Example 4, with the exception that the resin solution containing the luminous pigment was coated to the light reflecting layer. The results of the evaluation of this luminous wallpaper are shown in Table 4.

### Comparative Example 8

Luminous wallpaper was obtained in the same manner as in Example 4, with the exception that the quantity of luminous pigment employed was 50 parts. The results of the evaluation of this luminous wallpaper are shown in Table 4.

### Comparative Example 9

Luminous wallpaper was obtained in the same manner as in Example 4, with the exception that the quantity of white pigment contained in the light reflecting layer was decreased to 0.1 parts, and the L value thereof was less than 90. The results of the evaluation of this luminous sheet are shown in Table 4.

TABLE 4

| | | | Comp. | Comp. |
|---|---|---|---|---|
| | Ex. 4 | Ex. 5 | Ex. 8 | Ex. 9 |
| Quantity of luminescent agent (g/m²) | 85 | 85 | 32 | 85 |
| (value converted to a total surface | | | | |
| pattern) | | | | |
| Thickness of luminescent layer (μm) | 100 | 120 | 76 | 98 |
| Brightness of light reflecting layer, | 95 | 95 | 95 | 80 |
| L value | | | | |
| Evaluation of luminescence | A | A | C | D |
| Evaluation of pliability | good | partial | good | good |
| | | peeling | | |

### Example 6

A non-combustible paper having a basis weight (per cubic meter) of 250 g and a thickness of 100 μm was prepared as a sheet base material. A urethane resin solution (8000 cps) containing 100 parts polyester ether based single liquid urethane resin (solid component 30%), 50 parts toluene, and 50 parts white pigment having titanium oxide as the main component, was coated to one side thereof, and semi-dried for 30 seconds at 120° C., to form a light reflecting layer. Next, a urethane resin solution (9000 cps) containing 100 parts of a polyester ether based two liquid urethane resin (solid component 30%), 12 parts aliphatic isocyanate, 30 parts toluene, 50 parts flameproof agent, and 0.5 parts catalyst was coated to the light reflecting layer using a comma coater. This was then semi-dried for 30 seconds at 120° C., to obtain a laminate of the sheet base material, the light reflecting layer, and the flameproof layer.

Separate from the above, a resin solution containing 100 parts polyester ether based single liquid urethane resin (solid component 10%), 30 parts toluene, and 120 parts luminous pigment LumiNova® G300 (produced by Nemoto & Co., Ltd.) was coated onto releasable paper using a comma coater having a slit width of 150 μm, and dried for 30 seconds at 120° C. to form the luminescent layer. Next, the flameproof layer of the laminate and the aforementioned luminescent layer were adhered together. After aging for 24 hours at 60° C., the releasable paper was peeled off, to obtain a luminous wallpaper. The results of the evaluation thereof are shown in Table 5.

### Comparative Example 10

A commercially available wallpaper onto which a luminous pigment was deposited was employed as the sheet base material, to obtain a luminous wallpaper in the same manner as in Example 6. The results of the evaluation thereof are shown in Table 5.

### Comparative Example 11

A luminous wallpaper was obtained in the same manner as Example 6, with the exception that the quantity of luminous pigment employed was 50 parts. The results of the evaluation thereof are shown in Table 5.

### Comparative Example 12

A luminous wallpaper was obtained in the same manner as in Example 6, with the exception that the white pigment contained in the light reflecting layer was decreased to 0.1 parts, the L value thereof was less than 90, and the quantity of luminous pigment employed was 50 parts. The results of an evaluation thereof are shown in Table 5.

TABLE 5

| | | Comp. | Comp. | Comp. |
|---|---|---|---|---|
| | Ex. 6 | Ex. 10 | Ex. 11 | Ex. 12 |
| Quantity of luminescent agent (g/m²) | 85 | 17 | 32 | 85 |
| Thickness of luminescent layer (μm) | 100 | 20 | 80 | 100 |
| Brightness of flameproof layer, | 95 | 95 | 95 | 80 |
| L value | | | | |
| Evaluation of luminescence | A | E | C | D |
| Evaluation of pliability | good | partial | good | good |
| | | peeling | | |

### Example 7

A resin solution containing 100 parts polyester ether based single liquid urethane resin (solid component 10%), 40 parts toluene, and 120 parts luminous pigment LumiNova® G300 (produced by Nemoto & Co., Ltd.) was coated onto one side of polyethylene terephthalate (PET) sheet that had a thickness of 75 μm and a light transmissivity of 80% in the visible region using a comma coater having a slit width of 180 μm, and dried for 30 seconds at 120° C. to form the luminescent layer.

Next, a urethane resin solution (7000 cps) containing 100 parts polyester ether based single liquid urethane resin (solid component 30%) and 50 parts white pigment having titanium oxide as the main component, was coated to the luminescent layer, and dried for 40 seconds at 130° C., to form a luminous sheet. The results of an evaluation thereof are shown in Table 6.

### Comparative Example 13

A luminous sheet was prepared in the same manner as in Example 7, with the exception that the quantity of white pigment contained in the light reflecting layer was decreased to 0.1 parts and the L value thereof was less than 90. The results of the evaluation thereof are shown in Table 6.

### Comparative Example 14

A luminous sheet was obtained in the same manner as Example 7, with the exception that the quantity of luminous pigment employed was 50 parts. The results of the evaluation thereof are shown in Table 6.

### Comparative Example 15

A luminous sheet was prepared in the same manner as in Example 7, with the exception that the quantity of white pigment contained in the light reflecting layer was decreased to 0.1 parts and the quantity of luminous pigment employed was 50 parts. The results of the evaluation thereof are shown in Table 6.

TABLE 6

| | | Comp. | Comp. | Comp. |
|---|---|---|---|---|
| | Ex. 7 | Ex. 13 | Ex. 14 | Ex. 15 |
| Quantity of luminescent agent (g/m²) | 85 | 85 | 32 | 32 |
| Thickness of luminescent layer (μm) | 100 | 100 | 80 | 80 |
| Brightness of light reflecting layer, | 95 | 80 | 95 | 80 |
| L value | | | | |
| Evaluation of luminescence | A | B | C | D |

### Example 8

A resin solution containing 100 parts polyester ether based single liquid urethane resin (solid component 10%), 40 parts toluene, and 120 parts luminous pigment LumiNova® G300 (produced by Nemoto & Co., Ltd.), was coated to one side of a polyethylene terephthalate (PET) sheet that had a thickness of 75 μm and a light transmissivity of 80% in the visible region using a comma coater having a slit width of 180 μm, and dried for 30 seconds at 120° C. to form the luminescent layer.

Separate from the above, a urethane resin solution (8000 cps) containing 100 parts polyester ether based single liquid urethane resin (solid component 30%), 50 parts toluene, and 50 parts white pigment having titanium oxide as the main component, was coated onto releasable paper, and semidried for 30 seconds at 120° C. to form the light reflecting layer. Next, a urethane resin solution (9000 cps) containing 100 parts of a polyester ether based two liquid urethane resin (solid component 30%), 12 parts aliphatic isocyanate, 30 parts toluene, 50 parts flameproof agent, and 0.5 parts catalyst, was coated to the light reflecting layer using a comma coater. This was then semi-dried for 30 seconds at 120° C., to obtain a laminate of a light reflecting layer and a flameproof layer.

Next, the flameproof layer of the laminate and the aforementioned luminescent layer were adhered together. After aging for 24 hours at 60° C., the releasable paper was peeled off, to obtain a luminous sheet. The results of the evaluation thereof are shown in Table 7.

### Comparative Example 16

A luminous sheet was prepared in the same manner as in Example 8, with the exception that the quantity of white pigment contained in the light reflecting layer was decreased to 0.1 parts and the L value thereof was less than 90. The results of the evaluation thereof are shown in Table 7.

### Comparative Example 17

A luminous sheet was obtained in the same manner as Example 8, with the exception that the quantity of the luminous pigment employed was 50 parts. The results of the evaluation thereof are shown in Table 7.

### Comparative Example 18

A luminous sheet was prepared in the same manner as in Example 8, with the exception that the quantity of white pigment contained in the light reflecting layer was decreased to 0.1 parts and the quantity of luminous pigment employed was 50 parts. The results of the evaluation thereof are shown in Table 7.

TABLE 7

| | | Comp. | Comp. | Comp. |
|---|---|---|---|---|
| | Ex. 8 | Ex. 16 | Ex. 17 | Ex. 18 |
| Quantity of luminescent agent (g/m²) | 95 | 95 | 35 | 35 |
| Thickness of luminescent layer (μm) | 90 | 90 | 70 | 70 |
| Brightness of flameproof layer, | 95 | 80 | 95 | 80 |
| L value | | | | |
| Evaluation of luminescence | A | B | C | C |

The luminous sheets in Examples 1˜8 had a light reflecting layer and a luminescent layer in which the quantity of luminous pigment (value converted to total surface pattern in the case of a luminescent layer provided by screen printing) was in the range of 40 g/m²˜400 g/m². As a result, these sheets had high luminescence and pliability.

In contrast, the L value of the light reflecting layer or the flameproof layer in the luminous sheets in Comparative Examples 1, 4, 9, 12, 13, 15, 16 and 18 was less than 90, with luminescence being unsatisfactory as a result. Moreover, the quantity of luminous pigment in the luminous sheets in Comparative Examples 2, 3, 5˜8, 10, 11, 14, 15, 17 and 18 was less than 40 g/m². As a result, the luminescence of these sheets was unsatisfactory. Furthermore, the luminous sheets in Comparative Examples 5 and 10 employed a commercial wallpaper on which luminous pigment was deposited, such that pliability was not satisfactory.

The luminous sheet according to the present invention may be suitably employed in interior or industrial materials, such as covers for chairs or cushions, toys, decorative uses, safety indicators, etc.

1. A luminous sheet comprising a light reflecting layer and a luminescent layer in which a luminescent agent is included in the range of (40 to 400 g/m²)×(coverage ratio % /100%).

2. A luminous sheet according to claim 1, wherein the luminescent layer and the light reflecting layer are adjacent to each other.

3. A luminous sheet according to claim 2, wherein said light reflecting layer is a sheet base material having a L value of 90 or more.

4. A luminous sheet according to claim 1, further comprising a flameproof layer.

5. A luminous sheet according to claim 1, further comprising a sheet base material.

6. A luminous sheet according to claim 4, wherein the luminescent layer and the flameproof layer are adjacent to each other, and the flameproof layer and the light reflecting layer are adjacent to each other.

7. A luminous sheet according to claim 4, wherein said flameproof layer has a L value of 90 or more.

8. A luminous sheet according to claim 3, further comprising an adhesive layer to said sheet base material.

9. A luminous sheet according to claim 3, wherein the sheet base material is a wallpaper base material.

10. A luminous sheet according to claim 1, wherein the luminescent layer includes a polyurethane resin.

11. A luminous sheet according to claim 1, wherein a transparent sheet is adhered to the surface of the luminescent layer.

12. A production method for a luminous sheet, comprising a step for laminating one of either a light reflecting layer or a luminescent layer containing a luminescent agent in the range of 40˜400 g/m² to the other layer by coating.

13. A production method for a luminous sheet, comprising a step for laminating one of either a light reflecting layer or a luminescent layer containing a luminescent agent in the range of (40˜400 g/m²)×(coverage ratio % /100%) to the other layer by printing.

14. A production method for a luminous sheet, comprising a step for adhering a light reflecting layer and a luminescent layer containing a luminescent agent in the range of 40˜400 g/m² together.

15. A production method for a luminous sheet, comprising a step for laminating the light reflecting layer and the flameproof layer together, and a step for laminating one of either said flameproof layer or the luminescent layer containing a luminescent agent in the range of 40˜400 μm² to the other layer by coating.

16. A production method for a luminous sheet, comprising a step for laminating the light reflecting layer and the flameproof layer together, and a step for laminating one of either said flameproof layer or the luminescent layer containing a luminescent agent in the range of (40˜400 g/m²)×(coverage ratio % /100%) to the other layer by printing.

17. A production method for a luminous sheet, comprising a step for laminating the light reflecting layer and the flameproof layer are together, and a step for adhering said flameproof layer and the luminescent layer containing a luminescent agent in the range of 40˜400 g/m² together.

18. A production method for a luminous sheet according to claim 12, further comprising a step for laminating said light reflecting layer and the sheet base material together.

19. A production method for a luminous sheet according to claim 12, further comprising a step for laminating said light reflecting layer and the flameproof layer together.

20. A production method according to claim 12, wherein said luminescent layer and the transparent layer are laminated together.
